(19) United States
(12) Patent Application Publication
(10) Pub. No.: US 2026/0212008 A1
(43) Pub. Date: Jul. 23, 2026

(54) CODE STRUCTURING TO COMPLICATE AND IDENTIFY HACKING ATTEMPTS

(71) Applicant: Wells Fargo Bank, N.A., San Francisco, CA (US)

(72) Inventors: Nicholas R. Gillis, Martinsburg, WV (US); Samuel J. Cleveland, Spring Hill, TN (US); Michelle Baker, Littleton, CO (US)

(21) Appl. No.: 19/034,351

(22) Filed: Jan. 22, 2025

(51) Int. Cl. G06F 21/55

(52) U.S. Cl. CPC G06F 21/554; G06F 2221/033

(57) ABSTRACT

This disclosure describes techniques for both identifying and preventing, or at least complicating, efforts to hack a system in which code is stored in a web page. In one example, this disclosure describes a method that includes receiving, by a computing system and over a network from a client device, a request for a web page; identifying content responsive to the request; accessing a web page that includes the content responsive to the request and code referencing a first method and a second method, wherein the first method is configured to both call the second method and generate processing verification data, and wherein direct calls to the second method are redirected; outputting, responsive to the request, the web page to the client device; and determining, based on any processing verification data received from the client device over the network, whether the client device is operating as expected.

### TECHNICAL FIELD

This disclosure relates to networked computing systems, and more specifically, to techniques for preventing or complicating efforts to hijack or attack networked computing systems.

### BACKGROUND

Code written in some computer languages is compiled into a binary file before distribution to end-user devices for execution. Web pages that use JavaScript, on the other hand, distribute the JavaScript code in source form. As a result, code written in JavaScript and included within a web page can be easily viewed by anyone having access to the web page and a browser.

Obfuscation is a technique employed to transform code, often JavaScript code, into a less readable and more challenging-to-understand form, making it difficult for unauthorized individuals to reverse engineer or tamper with the code. Obfuscation transforms code into a form that is difficult to understand for humans, yet still functional for machines. Obfuscation is normally merely a deterrent, however, because in practice obfuscation alone does not provide effective protection against motivated bad actors.

### SUMMARY

This disclosure describes techniques for both identifying and preventing (or at least complicating) efforts to hack a system in which code exists in a web page in source form. In particular, described herein are certain redirection techniques used to ensure that a specific method call protocol is being properly followed by executing code, and also to ensure that various “check-in” processing also occurs, which serves to provide assurances that code is being executed as intended, rather than in ways not intended by the web page author.

Techniques described herein enable effective assessments of potential risks presented by interactions with client devices, and further enable calculation of risk scores quantifying those risks. Systems described herein may act on risk scores that suggest that one or more client devices represent a security threat, thereby preventing or at least mitigating deleterious effects of any such threat.

In some examples, this disclosure describes operations performed by a computing system in accordance with one or more aspects of this disclosure. In one specific example, this disclosure describes a method comprising receiving, by a computing system and over a network from a client device, a request for a web page; identifying, by the computing system, content responsive to the request; accessing, by the computing system, a web page that includes the content responsive to the request and code referencing a first method and a second method, wherein the first method is configured to call the second method and is further configured to generate processing verification data; outputting, by the computing system and responsive to the request, the web page to the client device; and determining, by the computing system and based on any processing verification data received from the client device over the network, whether the client device is operating as expected.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

This Summary is intended to provide a brief overview of some of the subject matter described in this document. Accordingly, the above-described features are merely examples and should not be construed to narrow the scope or spirit of the subject matter described herein. Other features, objects, and advantages of the disclosure will be apparent from the description and drawings, and from the claims.

### BRIEF DESCRIPTION OF THE DRAWINGS

FIG. 1A is a conceptual diagram illustrating an example web server that serves web pages containing code that is structured to identify, complicate, and/or prevent hacking attempts, in accordance with one or more aspects of the present disclosure.

FIG. 1B is a flow diagram illustrating how method calls to various functions described in FIG. 1A may be processed, in accordance with one or more aspects of the present disclosure.

FIG. 1C is a flow diagram illustrating the renaming of functions as a result of an obfuscation procedure, in accordance with one or more aspects of the present disclosure.

FIG. 2 is a conceptual diagram that includes a block diagram illustrating an example computing system that serves web pages containing code that is structured to identify, complicate, and/or prevent hacking attempts, in accordance with one or more aspects of the present disclosure.

FIG. 3 is a flow diagram illustrating operations performed by an example web server or computing system, in accordance with one or more aspects of the present disclosure.

FIG. 4A is a flow diagram illustrating how method calls to various functions in a JavaScript implementation may be processed, in accordance with one or more aspects of the present disclosure.

FIG. 4B is a code listing illustrating how JavaScript code implementing some of the techniques described herein may be implemented, in accordance with one or more aspects of the present disclosure.

FIG. 5 is a flow diagram illustrating operations performed by an example computing system, in accordance with one or more aspects of the present disclosure.

Although each of the above-described Figures are referenced herein in connection with the description of one or more specific examples, such examples are merely illustrative, and each illustration can be used to provide support for other examples not specifically described herein. Accordingly, any examples described herein with reference to the above-described Figures should not be construed to narrow the scope or spirit of the subject matter illustrated or otherwise disclosed herein.

### DETAILED DESCRIPTION

Most developers write JavaScript code in a manner consistent with standard usage practices, such as listening for events using “Window.addEventListener” and making HTTP requests using “Window.URL,window.XMLHTTPRequest.” These are well-known standard objects and function calls within JavaScript. And since these objects are well-known, they are also well-known to malicious actors and attackers.

JavaScript is a flexible language, however, and it is possible that a web page could implement JavaScript code without explicitly using these and other standard objects. For example, a public-facing external web page might not contain explicit references to these objects, but instead, could use calls to a custom-built wrapper around those objects and functions. The wrapper might then call the well-known objects internally, effectively hiding in the external web page any references to well-known standard objects and functions. Using techniques described herein, which in some examples involve use of what might be considered a custom-built wrapper, it may be possible to prevent or at least complicate efforts by malicious actors seeking to use information derived from code included in a web page in an unauthorized or unintended way.

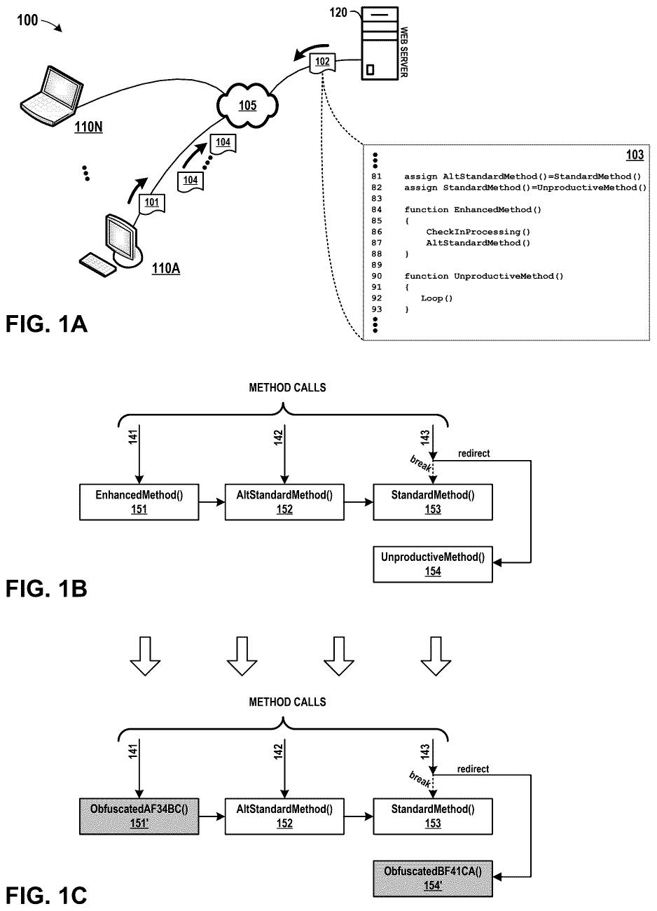

FIG. 1A is a conceptual diagram illustrating an example web server that serves web pages containing code that is structured to identify, complicate, and/or prevent hacking attempts or unauthorized use of the code, in accordance with one or more aspects of the present disclosure. System 100 of FIG. 1A includes web server 120 and any number of client devices, including client device 110A through client device 110N (“client devices 110”). Web server 120 and client devices 110 are capable of communicating over network 105, which may be a private or public network, such as the internet. Web server 120 may be implemented using any suitable computing system or collection of computing systems, including one or more server or web server computers, workstations, mainframes, appliances, cloud computing systems, and/or other computing devices that may be capable of performing operations and/or functions described in accordance with one or more aspects of the present disclosure. In some examples, such systems may represent or be implemented through one or more virtualized compute instances (e.g., virtual machines, containers) of a data center, cloud computing system, server farm, and/or server cluster.

Client devices 110 may be any appropriate computing device that may serve as a client device in a networked environment. In many cases, legitimate client devices 110 are operated by a user, but one or more of client devices 110 may be operated as an automated system, particularly if under the control of a hacker or malicious user. In general, client devices 110 may be implemented through any type of computing device capable of engaging in communications and/or performing functions consistent with the techniques described herein. Accordingly, client devices 110 may be implemented through any suitable computing system including any mobile, non-mobile, wearable, and/or non-wearable computing device, which may be a mobile phone or tablet, or a laptop or desktop computing device. Client devices 110 can take many forms, which could include a computerized watch, a computerized glove or gloves, a personal digital assistant, a virtual assistant, a gaming system, a media player, an e-book reader, a television or television platform, a bicycle, automobile, or navigation, information and/or entertainment system, or any other type of wearable, non-wearable, mobile, or non-mobile computing device that may perform operations in accordance with one or more aspects of the present disclosure.

In operation, any of client devices 110 may issue a request to web server 120, and in response, the requesting client device may receive a web page from web server 120. That web page can then be rendered on a display associated with the client device. For example, as illustrated in FIG. 1A, client device 110A issues request 101 to web server 120, and web server 120 responds to that request 101 with a web page 102. As further described herein, while client device 110A processes and/or interacts with web page 102, client device 110A may communicate a series of processing verifications 104 over network 105 to web server 120.

FIG. 1A illustrates an excerpt of code or pseudocode 103 that might be included within web page 102. In general, web pages, including web page 102, may include code to be executed within a browser executing at client device 110A. Pseudocode 103 is intended to represent an example of such code. Often, code included within an HTML web page is written in JavaScript, which is embedded as text within the web page and is readily available to be viewed, analyzed, or stored by any person downloading the web page containing the JavaScript code. Accordingly, a hacker or other actor generally has access to some or all aspects of such code executed within the web page, and therefore can generally reverse engineer the code, determine how the JavaScript application within the web page 102 operates, and identify functions that cause web server 120 to perform productive operations (e.g., authenticate a username and password, provide information, engage in communications with another system). Using this knowledge, a hacker could inject or otherwise execute code that calls some of these same functions, and thereby cause web server 120 to perform those same productive operations for unintended or unauthorized purposes. For example, a hacker might identify a function that causes web server 120 to validate or authenticate a username and password. The hacker might then inject code that automatically calls the identified function millions of times to test a series of possible usernames and passwords in an attempt to identify username and password combinations that are recognized by web server 120 as valid. As a result, the relatively transparent way in which the JavaScript code is delivered to the browser for execution creates opportunities for bad actors to cause web server 120 to operate in an unintended or inappropriate or even malicious manner.

Various techniques are sometimes used to combat attempts to reverse engineer code within a web page, such as obfuscation techniques that may include changing the names of functions, variables, and other code elements to hide their true purpose. However, as previously suggested, obfuscation is relatively easy to defeat in practice, and actors seeking to obfuscate the code are often successful.

Pseudocode 103 illustrates coding techniques that may be more effecting in preventing, frustrating, or at least complicating processes that a hacker or other actor might use to cause web server 120 to perform unauthorized operations. Pseudocode 103 is intended to represent generalized code that may correspond to code implementing the described techniques in any language that might execute within a browser on any of client devices 110, or within any applicable code execution environment. Accordingly, pseudocode 103 illustrates a general technique that could be implemented in JavaScript, but which may be applicable to other languages. Techniques described herein may therefore take other forms than that illustrated in FIG. 1A, whether as JavaScript, another language, or within any applicable execution environment now known or hereafter developed.

Thirteen lines of code (numbered 81 to 93) within the excerpt represented by pseudocode 103 are shown in FIG. 1A. Lines 81 and 82 illustrate how certain functions may be redirected, renamed, or otherwise modified in a way that alters how functions called by code executing within the browser (or injected into the browser) may execute. For example, in line 81, the method “AltStandardMethod()” is assigned to “StandardMethod(),” which has the effect of causing calls to AltStandardMethod() to be redirected to the StandardMethod() function. JavaScript is a flexible language that allows functions or renamed in this way, enabling nearly any function to be renamed and/or redirected. In the context of JavaScript, AltStandardMethod() may be considered a prototype function or other function. StandardMethod() may be a library or standard function, such as a function that is built into JavaScript or that performs a service provided by the JavaScript environment. Such a function can be called by code within the browser to cause the browser to perform a function.

For example, again using JavaScript as an example, the “StandardMethod()” function may correspond to the “Window.addEventListener” method of the Event Target interface in JavaScript, which can be called to configure a function to be called whenever the specified event is delivered to the target. In a different JavaScript example, “StandardMethod()” may correspond to the “Math.Random” function in JavaScript that, when called, causes the browser to generate a random floating-point number.

In at least some examples herein, “StandardMethod()” is therefore a standard defined function provided as a built-in service (e.g., “Window.addEventListener”or “Math.Random”) in the applicable environment (e.g., JavaScript). However, in other examples, “StandardMethod()” may also be a user-defined function, and techniques described herein may also be applicable to implementations in which “StandardMethod()” may correspond to a user-defined or user-written function. In general, whether “StandardMethod()” is a user-defined function or one that corresponds to a service provided by an execution environment (e.g., JavaScript), “StandardMethod() is a function that a hacker may seek to call when attempting to induce web server 120 to perform an operation through injected or otherwise unauthorized code.

In line 82, the method “StandardMethod()” is assigned to “UnproductiveMethod(),” which has the effect of causing calls directly to “StandardMethod()” to be redirected to the “UnproductiveMethod(),” which is defined starting at line 90 of pseudocode 103. Again assuming that the “StandardMethod()” function corresponds to the JavaScript “Math.Random()” function, the effect of line 82 is that calls to “StandardMethod()” are automatically converted to or result in a call to “UnproductiveMethod(),” so that calls directly to the “Math.Random()” JavaScript function never execute as expected, and never generate a random number. However, calls to “AltStandardMethod(),” as described above, still result in a call to the original Math.Random() method, and therefore still cause the browser to generate random floating-point number.

Lines 84 through 88 define a function, “EnhancedMethod(),” which first calls a “CheckInProcessing()” function, and then calls the “AltStandardMethod()” function. The CheckInProcessing() function causes various interactions with web server 120 to occur and/or otherwise causes the client device to communicate with web server 120. Specifically, and as illustrated in FIG. 1A, when client device 110A executes the CheckInProcessing() function, client device 110A may cause one or more items of data, indicated as processing verifications 104 in FIG. 1A, to be communicated over network 105 to web server 120. Web server 120 uses these processing verifications 104 to verify that specific processes and protocols have been performed or followed by client device 110A, which enables web server 120 to determine whether client device 110A is operating as expected (and is therefore a legitimate client device 110) or whether it is not operating as expected (and is a device that may be operated by a hacker or other bad actor, or is a legitimate client device 110 that has been hijacked by a hacker). In some examples, web server 120 may determine a risk score for client device 110A based on processing verifications 104 received from client device 110A (or the lack of processing verifications 104 received from client device 110A). Web server 120 may change its operations based on such a risk score (e.g., web server 120 may require additional authentication, delay funds transfers, restrict privileges to a user of client device 110A, modify operation of network 105, or other perform other operations).

Lines 90 through 93 define a second function, “UnproductiveMethod(),” which performs processing that generally is considered unproductive, and may serve as a trap that complicates or frustrates method calls made by a hacker's unauthorized code. For example, in the implementation illustrated in FIG. 1A, UnproductiveMethod() may execute a long-running or infinite loop (as indicated by the pseudocode “Loop()”), which may cause significant processing cycles to be consumed by client device 110A as the code executes within the browser at client device 110A. Note that in lines 82, StandardMethod() is assigned or redirected to UnproductiveMethod(), so the effect of a hacker's calls directly to StandardMethod() (where StandardMethod() might be a call to JavaScript's Math. Random function) will be the execution of this unproductive code. In general, “unproductive” operation in the context of “Math.Random()” may mean any operation other than the expected Math. Random service of generating a random floating-point number.

FIG. 1B is a flow diagram illustrating how method calls to various functions described in FIG. 1A may be processed, in accordance with one or more aspects of the present disclosure. FIG. 1B illustrates the effect of pseudocode 103 of FIG. 1A. In FIG. 1B, method calls 141, 142, and 143 are illustrated as arrows to a box representing a function. Method call 141 represents a call to EnhancedMethod() 151, which corresponds to the function of the same name described in pseudocode 103 of FIG. 1A. Method call 142 represents a call to AltStandardMethod() 152, corresponding to the function of the same name in FIG. 1A, and method call 143 represents a call to StandardMethod() 153, corresponding to the “StandardMethod()” function of pseudocode 103.

FIG. 1B illustrates that method call 143 to StandardMethod() is redirected to UnproductiveMethod() 154, which is the effect of line 82 of pseudocode 103 of FIG. 1A. Accordingly, line 82 effectively “breaks” the standard operation of StandardMethod() 153, since any code that makes a call directly to StandardMethod() 153 is redirected to UnproductiveMethod() 154, and the code in StandardMethod() 153 does not execute as a result of such a call. Method call 142 to AltStandardMethod() 152, however, does result in a call to StandardMethod() 153, since the effect of line 81 of pseudocode 103 in FIG. 1A is that calls to AltStandardMethod() 152 are redirected to the underlying StandardMethod() 153. Similarly, method call 141 to EnhancedMethod() 151 also eventually results in a call to StandardMethod() 153, because EnhancedMethod() 151 calls AltStandardMethod() 152, which calls StandardMethod() 153. StandardMethod() 153 is called as a result of a method call 141 in this situation because in the EnhancedMethod() function starting at line 84 of pseudocode 103, a call is made to AltStandardMethod() at line 87 of pseudocode 103 (after first calling the “CheckInProcessing()” function at line 86).

The redirection of method calls illustrated in FIG. 1B can be effective in preventing or at least complicating a hacker's attempt to analyze and execute code contained within a web page 102 to perform unauthorized operations, since at least some of the method calls illustrated in FIG. 1B might not work as a hacker might initially expect. For example, if a hacker seeks to execute StandardMethod() 153, the hacker will need to first determine that a direct method call 143 will not produce the desired result, since method calls 143 have been redirected to execute other (unproductive) code. The hacker might eventually determine that method call 142 will result in the desired result, since method call 142 executes AltStandardMethod() 152, which does successfully call (through redirection) StandardMethod() 153. Yet method calls 142 directly to AltStandardMethod() 152 differ from method calls 141 to EnhancedMethod() 151, since EnhancedMethod() 151 also includes a call to “CheckInProcessing().” That CheckInProcessing() function is important because it causes processing verifications 104 to be sent to web server 120 over network 105, and web server 120 may use those processing verifications 104 to verify that the code being executed at client device 110A is following the method call protocol expected by web server 120. In general, legitimate code (e.g., code authorized by the organization controlling web server 120) will nearly always call EnhancedMethod() 151, since any method calls 143 to StandardMethod()s 153 (e.g., by a hacker) will not be successful, even for code authorized by the organization controlling web server 120. Further, while any method calls 142 to AltStandardMethod() 152 may cause the underlying StandardMethod() (e.g., corresponding to Math.Random() in JavaScript) to execute as desired, the lack of processing verifications 104 received by web server 120 when such method calls 142 are made will highlight that any client device 110 making method calls 142 is not following the prescribed protocol (and therefore might be flagged as not executing legitimate code). Accordingly, a hacker or other actor seeking to execute code at web server 120 in an unintended way will have to decipher and understand the new method call structure diagrammed in FIG. 1B and ensure that all calls to StandardMethod() are made using EnhancedMethod() 151. This process of deciphering will take time and will significantly complicate efforts to automate large scale malicious processes that seek to cause web server 120 to perform unauthorized operations.

FIG. 1C is a flow diagram that is similar to the flow diagram of FIG. 1B, after some of the names of the functions illustrated in the flow diagram of FIG. 1B have been changed as a result of an obfuscation procedure, in accordance with one or more aspects of the present disclosure. Specifically, as indicated by the arrows at the top of FIG. 1C, obfuscation techniques have been applied to the flow diagram of FIG. 1B to transform the flow diagram into the one illustrated in FIG. 1C. In FIG. 1C, EnhancedMethod() 151 has been renamed to be ObfuscatedAF34BC() 151′ and UnproductiveMethod() 154 has been renamed to be ObfuscatedBF41CA() 154′. The renaming of these functions in this way is intended to hide any description or the true nature of the functions performed by these methods. Such obfuscation techniques may be applied frequently, and in some examples, EnhancedMethod() 151 and/or UnproductiveMethod() 154 might be renamed each time a new web page 102 is requested from web server 120. Accordingly, with such frequent renaming, a hacker would need to be able to somehow determine, for each new page load, the name of the correct EnhancedMethod() 151 function in order to correctly and properly access the service provided by StandardMethod() 153. Legitimate code generated at web server 120, however, may be privy to the process by which these functions are renamed, and therefore, legitimate code generated at web server 120 is able to correctly call the renamed function each time, even if the name of one or more functions within the web page changes on each page load.

Further, when calling the renamed version of EnhancedMethod() 151, a hacker would also need to ensure that calls to CheckInProcessing() generate processing verifications 104 in a way that would appear legitimate when such processing verifications 104 are received by web server 120. In situations where processing verifications 104 are generated based on user input, user interactions, processing time, or other processes that might be difficult for an automated hacker device to emulate, even in that situation web server 120 might be able to determine that a hacker's calls to EnhancedMethod() 151′ are not legitimate.

The effect of obfuscating function or method names, as described herein, is to further complicate the process that a hacker or bad actor might need to complete in order to decipher and understand the new method call structure diagrammed in FIG. 1B and FIG. 1C. Although FIG. 1A, FIG. 1B, and FIG. 1C are described with respect to performing redirection around one specific function (i.e., StandardMethod() 153), in practice similar techniques may apply to many functions, complicating a hacker's attempt to make calls to any number of functions that may be used or defined in a given web page 102 or collection of web pages 102.

Techniques described herein may provide certain technical advantages. For instance, by preventing, or at least complicating, processes by which malicious actors may use to gain access to functions provided by web server 120 or other systems, it is possible to prevent or reduce damage caused by such malicious actors. These techniques could be effective to prevent skimming, disable malware, and protect end-users and services in a non-intrusive way.

In addition, by altering the way in which functions are called in code transparently included within a web page and by further monitoring check-ins that are expected to be performed, it may be possible to identify instances where anomalous or unusual activity is taking place on a user or client device. Further, by using obfuscation techniques to frequently change the name of those functions, it may be possible to further complicate attempts to hack a web site or similar system, and thereby reduce risks posed by malicious actors and prevent financial, computational, reputational, or other types of loss. Still further, authorized third parties can nevertheless still interact with web server 120 in this system, since trusted third parties (e.g., vendor) may still need to interact with web server 120 and access services provided by web server 120. To do so, the third party may use documentation provided by the organization operating web server 120 to learn how to properly follow the required protocol.

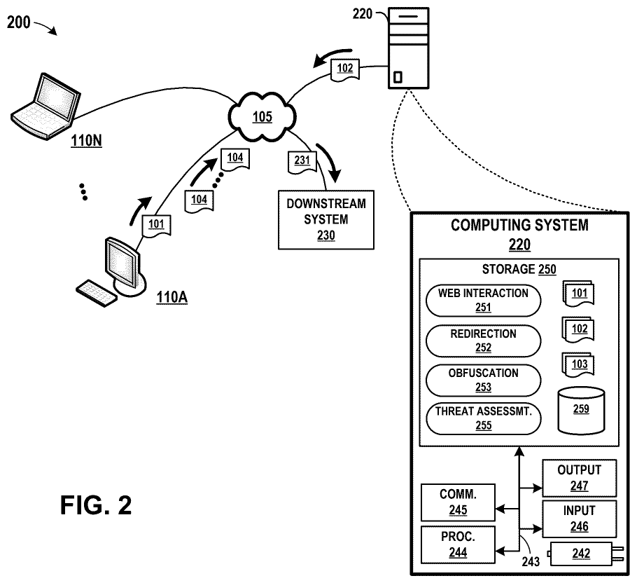

FIG. 2 is a conceptual diagram that includes a block diagram illustrating an example computing system that serves web pages containing code that is structured to prevent hacking attempts or unauthorized use of the code, in accordance with one or more aspects of the present disclosure. System 200 of FIG. 2 includes many of the same elements of system 100 described in connection with FIG. 1A. Elements illustrated in FIG. 2 may correspond to earlier-described elements sharing the same reference numeral.

Also illustrated in FIG. 2 is a block diagram version of computing system 220, which may be considered an example or alternative implementation of web server 120 of FIG. 1. Computing system 220 of FIG. 2 may operate in a manner similar to web server 120 illustrated in FIG. 1. For example, computing system 220 may respond to requests 101 with web pages 102 as described in connection with FIG. 1A. Computing system 220 is illustrated in FIG. 2 to facilitate a description of certain components, modules, and other aspects of a computing system that may implement a system for combating unintended use of code included in web pages 102, such as described in FIG. 1A, FIG. 1B, and FIG. 1C. Computing system 220 is also illustrated in FIG. 2 to facilitate a description of how such a computing system may operate in accordance with techniques described herein.

FIG. 2 also illustrates computing system 220 communicating with downstream system 230 over network 105. Downstream system 230 may represent any system that might be controlled or whose operation may be modified by one or more control signals 231 received from computing system 220. For example, downstream system 230 may be a network device (e.g., router or firewall), financial system (e.g., banking or accounting system), business system (e.g., order-taking system or commerce-enabling system), or any other system that might be modified, adjusted, or controlled at least partially by computing system 220. In some examples, computing system 220 may determine a risk score associated with one or more client devices 110 (or users of such client devices 110) and determine that downstream system 230 should be adjusted to prevent or mitigate a threat indicated by the high risk score. Alternatively, in some examples, computing system 220 may determine that a risk score associated with one or more client devices 110 suggests that the operation of downstream system 230 can be adjusted in a different way because the risk scores suggest that threat levels are low.

For ease of illustration, computing system 220 is depicted in FIG. 2 as a single computing system. However, in other examples, computing system 220 may be implemented through multiple devices or computing systems distributed across a data center, multiple data centers, multiple cloud networks, or otherwise. For example, separate computing systems may implement functionality described herein as being performed by each of various modules of computing system 220, including web interaction module 251, verification module 252, obfuscation module 253, and threat assessment module 255. Alternatively, or in addition, modules illustrated in FIG. 2 as included within computing system 220 may be implemented through distributed virtualized compute instances (e.g., virtual machines, containers) of a data center, cloud computing system, server farm, and/or server cluster.

In FIG. 2, computing system 220 is shown with underlying physical hardware that includes power source 242, one or more processors 244, one or more communication units 245, one or more input devices 246, one or more output devices 247, and one or more storage devices 250. One or more of the devices, modules, storage areas, or other components of computing system 220 may be interconnected to enable inter-component communications (physically, communicatively, and/or operatively). In some examples, such connectivity may be provided by through communication channels, which may include a system bus (e.g., communication channel 243), a network connection, an inter-process communication data structure, or any other method for communicating data. Although computing system 220 of FIG. 2 may be considered an example implementation of web server 120 of FIG. 1A, other implementations are possible.

In the example shown in FIG. 2, power source 242 of computing system 220 may provide power to one or more components of computing system 220. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 244 to intelligently consume, allocate, supply, or otherwise manage power. Storage devices 250 may include web interaction module 251, verification module 252, obfuscation module 253, threat assessment module 255, and data store 259.

One or more processors 244 of computing system 220 may implement functionality and/or execute instructions associated with computing system 220 or associated with one or more modules illustrated herein and/or described herein. One or more processors 244 may be, may be part of, and/or may include processing circuitry that performs operations in accordance with one or more aspects of the present disclosure. Such processors may be mobile processors, desktop processors, server processors, compute nodes, virtualized processors, neural processing units or NPUs, graphics processing units or GPUs, and/or other types of processors or processing circuitry. Processors 244 may execute the instructions of one or more processes executing on computing system 220 and may implement functionality of such processes.

One or more communication units 245 of computing system 220 may communicate with devices external to computing system 220 by transmitting and/or receiving data, and may operate, in some respects, as both an input device and an output device. Communication units 245 may enable computing system 220 to communicate with other computing devices and systems using any appropriate communication protocol (e.g., TCP/IP) and over any appropriate medium. In some or all cases, one or more communication units 245 may communicate with other devices or computing systems over a network. For example, communication units 245 may enable computing system 220 to communicate with any other device illustrated in FIG. 2, such as client devices 110 over network 105 or one or more downstream systems 230 (over network 105 or another network that is not specifically shown in FIG. 2).

One or more input devices 246 may represent any input devices of computing system 220, and one or more output devices 247 may represent any output devices of computing system 220. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 220 may store information for processing during operation of computing system 220. Storage devices 250 may store program instructions and/or data associated with one or more of the modules described in accordance with one or more aspects of this disclosure. One or more processors 244 and one or more storage devices 250 may provide an operating environment or platform for such modules, which may be implemented as software, but may in some examples include any combination of hardware, firmware, and software. One or more processors 244 may execute instructions and one or more storage devices 250 may store instructions and/or data of one or more modules. The combination of processors 244 and storage devices 250 may retrieve, store, and/or execute the instructions and/or data of one or more applications, modules, or software. Processors 244 and/or storage devices 250 may also be operably coupled to one or more other software and/or hardware components, including, but not limited to, one or more of the components of computing system 220 and/or one or more devices or systems illustrated or described as being connected to computing system 220.

Web interaction module 251, included within storage devices 250, may perform functions relating to serving web pages 102 in response requests 101 from client devices 110. In general, web interaction module 251 may perform functions corresponding to the web server functionality described in connection with web server 120 of FIG. 1A.

Verification module 252 may perform functions relating to modifying code included in web pages 102 in order to redirect or change how method calls to various functions may be executed or processed, and also in order to cause various processing check-ins (or processing verifications 104) to be generated and delivered to computing system 220 by a client device. In general, verification module 252 may perform functions corresponding to those previously described with reference to pseudocode 103 of FIG. 1A and method calls previously described with reference to FIG. 1B.

Obfuscation module 253 may perform functions relating to modifying code included within web pages 102 in order to obfuscate or complicate the names of functions called by legitimate code within a given web page 102. In general, obfuscation module 253 may perform functions corresponding to those described in connection with FIG. 1C.

Threat assessment module 255 may perform functions relating to determining a risk score based on, for example, processing verifications 104 (or lack thereof) received from client devices 110. Threat assessment module 255 may also perform functions relating to acting on such risk scores. In some examples, threat assessment module 255 may send control signals 231 to one or more downstream systems 230 in order to modify or affect at least some aspects of the operation of such downstream systems 230.

Data store 259 of computing system 220 may represent any suitable data structure or storage medium for storing information relating to operations performed by web interaction module 251, verification module 252, obfuscation module 253, and/or threat assessment module 255. Such information may include requests 101, web pages 102, pseudocode 103, and/or processing verifications 104. The information stored in data store 259 may be searchable and/or categorized such that one or more modules within computing system 220 may provide an input requesting information from data store 259, and in response to the input, receive information stored within data store 259. Data store 259 may be primarily maintained by threat assessment module 255.

Modules illustrated in FIG. 2 (e.g., web interaction module 251, verification module 252, obfuscation module 253, and threat assessment module 255) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

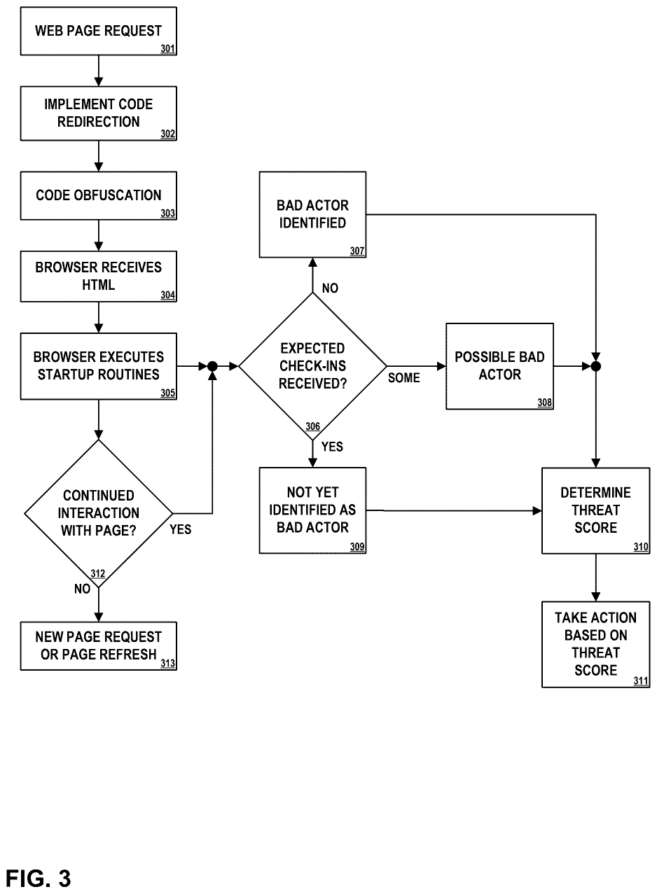

FIG. 3 is a flow diagram illustrating operations performed by an example web server or computing system, in accordance with one or more aspects of the present disclosure. FIG. 3 is described below within the context of computing system 220 of FIG. 2 receiving a web page request from one of client devices 110, such as client device 110A, and responding to the request with web page 102. In other examples, operations described in FIG. 3 may be performed by one or more other components, modules, systems, or devices. Further, in other examples, operations described in connection with FIG. 3 may be merged, performed in a different sequence, omitted, or may encompass additional operations not specifically illustrated or described.

In operation, and in accordance with one or more aspects of the present disclosure, computing system 220 may receive a request for a web page (301). For instance, in an example that can be described in the context of FIG. 2, communication unit 245 of computing system 220 detects a signal over network 105 and outputs information about the signal to web interaction module 251. Web interaction module 251 determines that the signal corresponds to request 101, which is a request for a web page originating from client device 110A.

Computing system 220 may implement code redirection (302). For instance, again with reference to FIG. 2, web interaction module 251 identifies web page 102 as responsive to the web page request. Web interaction module 251 outputs information about web page 102 to verification module 252. Verification module 252 implements and/or structures the code within the requested web page 102 to implement a redirection of certain methods of functions, such as in the manner illustrated in connection with FIG. 1B. Verification module 252 also implements code that causes client devices 110 to generate various processing verifications 104 and deliver such verifications to computing system 220.

Computing system 220 may perform code obfuscation (303). For instance, still with reference to FIG. 2, web interaction module 251 outputs information about web page 102 to obfuscation module 253. Obfuscation module 253 modifies the JavaScript code that is to be included within web page 102 pursuant to an obfuscation procedure, which may involve changing the names of one or more methods, variables, and/or other code elements included within web page 102. In some examples, obfuscation module 253 performs obfuscation processes on web page 102 after verification module 252 implements the redirection and/or restructuring of code within web page 102. In other examples, obfuscation module 253 may perform these tasks before verification module 252 processing is completed.

Computing system 220 may enable client device 110A to receive web page 102 (304). For instance, again with reference to FIG. 2, web interaction module 251 of computing system 220 causes communication unit 245 to output web page 102 over network 105. Client device 110A receives a signal over network 105 that it determines corresponds to a web page responsive to request 101.

Computing system 220 may enable client device 110A to execute startup routines (305). For instance, client device 110A begins processing the received web page (i.e., web page 102) by loading the received web page into a web browser. The web browser parses HTML included in the web page and begins rendering elements of web page 102 on a display associated with client device 110A. In some examples, the web page may prompt a user of client device 110A for information, such as a username and password. Client device 110A may also start executing any code (e.g., JavaScript) included within web page 102. In some examples, such code may cause one or more processing verifications 104 to be sent by client device 110A over network 105 to computing system 220. Such processing verifications 104 may provide information about processes performed by client device 110A associated with the browser executing startup routines and other processes.

Computing system 220 may receive check-in information or processing verifications 104 (306). For instance, communication unit 245 of computing system 220 detects a series of signals over network 105. Web interaction module 251 of computing system 220 determines that the series of signals corresponds to processing verifications 104 received from client device 110A. Web interaction module 251 further determines that the processing verifications 104 are associated with startup routines performed by client device 110A when loading web page 102 at client device 110A. Web interaction module 251 evaluates processing verifications 104 and determines whether they are consistent with expected operation of client device 110A when rendering web page 102. In some examples, such processing verifications 104 may correspond to “check-ins” or processing checks that define a signature of the processing flow or sequence of events that are expected to happen at client device 110A when web page 102 is loaded in a browser at client device 110A. Such processing checks may correspond to or be based on processing or computations performed by client device 110A, based on processing of input from a user of client device 110A (e.g., keystrokes, mouse movements), based on processing or transfer of data by client device 110A, and/or based on the time consumed by such processing.

Computing system 220 may determine that client device 110A is operated by a bad actor (307 and NO path from 306). For instance, again referring to FIG. 2, web interaction module 251 of computing system 220 determines that web page 102 has been delivered to client device 110A. For example, web interaction module 251 may receive information from client device 110A over network 105 about variable values from the web instance associated with web page 102 and client device 110A,. Computing system 220 may receive requests from client device 110A for components of web page 102 (e.g., images) as web page 102 is being rendered at client device 110A. At some point, web interaction module 251 further determines that if client device 110A is operating normally or as expected, client device 110A should have sent a series of processing verifications 104 over network 105 to computing system 220. In some cases, the processing verifications 104 may be generated by operations performed by one or more “check-in” processing routines (e.g., see line 86 of pseudocode 103 in FIG. 1A). If legitimate code will almost always perform a specific set of operations that cause processing verifications 104 to be sent over network 105 to computing system 220 (e.g., as a result of calling EnhancedMethod()—see FIG. 1A), then computing system 220 can expect to receive those processing verifications 104 from legitimate client devices. However, if computing system 220 never receives those processing verifications 104 from client device 110A, then web interaction module 251 may classify client device 110A as a rogue device or one operated by a malicious actor (307 and NO path from 306).

If some, but not all, of those processing verifications 104 are received by computing system 220, then the classification of the client device is indeterminate. Web interaction module 251 may determine that client device 110A is possibly a bad actor, though there could legitimate reasons for some processing verifications 104 to not be received by computing system 220 (308 and SOME path from 306). And if web interaction module 251 determines that all of the processing verifications 104 are received from client device 110A as expected, then web interaction module 251 may conclude that there is not any evidence that client device 110A is a rogue device or is operated by a malicious actor (309 and YES path from 306).

Computing system 220 may determine a threat score (310). For instance, referring again to FIG. 2, web interaction module 251 outputs to threat assessment module 255 information about the interactions between computing system 220 and client device 110A. Such interactions may include information about any processing verifications 104 that client device 110A has sent to computing system 220. Threat assessment module 255 evaluates the information to calculate a risk score, which may represent the extent to which client device 110A presents a risk to computing system 220 or other systems or assets associated with computing system 220. Threat assessment module 255 may base the risk score on processing verifications 104 received from client device 110A (if any) as well as other information, such as historical information about client device 110A or the purported user operating client device 110A. If computing system 220 is operated by an organization such as a bank, threat assessment module 255 may determine the risk score based on other information, such as historical information about the purported account holder (i.e., the user of client device 110A, attributes of the account holder's assets, privileges, or relevant circumstances).

Computing system 220 may take action based on the threat score (311). For instance, still with reference to FIG. 2, threat assessment module 255 evaluates the calculated risk score and determines whether an action should be taken based on the risk score. If the risk score is sufficiently low, indicating little or no risk associated with client device 110A, threat assessment module 255 might not take any action. If the risk score is high, indicating that client device 110A represents some risk to computing system 220 or another system, threat assessment module 255 may take action to prevent, mitigate, or address consequences that may result from the risk. To do so, threat assessment module 255 may cause communication unit 245 of computing system 220 to output one or more control signals 231 to one or more downstream systems 230, to thereby control downstream system 230 to carry out an operation or change its operation in order to prevent, mitigate, or address consequences that may result from the risk. If computing system 220 is operated by a commercial organization, such as a bank, downstream system 230 may be a network device or financial risk mitigation system that can limit funds transfers, harden external network defenses, raise alerts, communicate with other systems or organizations to address potential financial consequences that may flow from the risk posed by client device 110A, or take other actions.

Computing system 220 may continue to monitor interactions (312). For instance, still referring to FIG. 2, client device 110A may continue to interact with computing system 220 as a result of a user's continued interactions with web page 102 being presented at client device 110A. For example, web page 102 may serve as an interactive application that enables users to perform various functions during the course of an extended web session in which interactions between client device 110A and computing system 220 occur. Web page 102 may be designed to continue to send processing verifications 104 during these interactions. Web interaction module 251 may monitor the receipt of such processing verifications 104 and may continue to determine whether the expected check-ins continue to be received. Based on processing verification 104 and other factors, threat assessment module 255 may update a risk score associated with the client device and/or continue to update the classification of the user operating client device 110A, which may involve classifying the user (or client device 110A) as a bad actor (307), a possible bad actor (308), or not identified as a bad actor (309).

This process may continue until computing system 220 receives a page refresh request or a new page is requested (313). Accordingly, continued monitoring, and continued updating of a risk score may take place across the entire session during which client device 110A interacts with computing system 220.

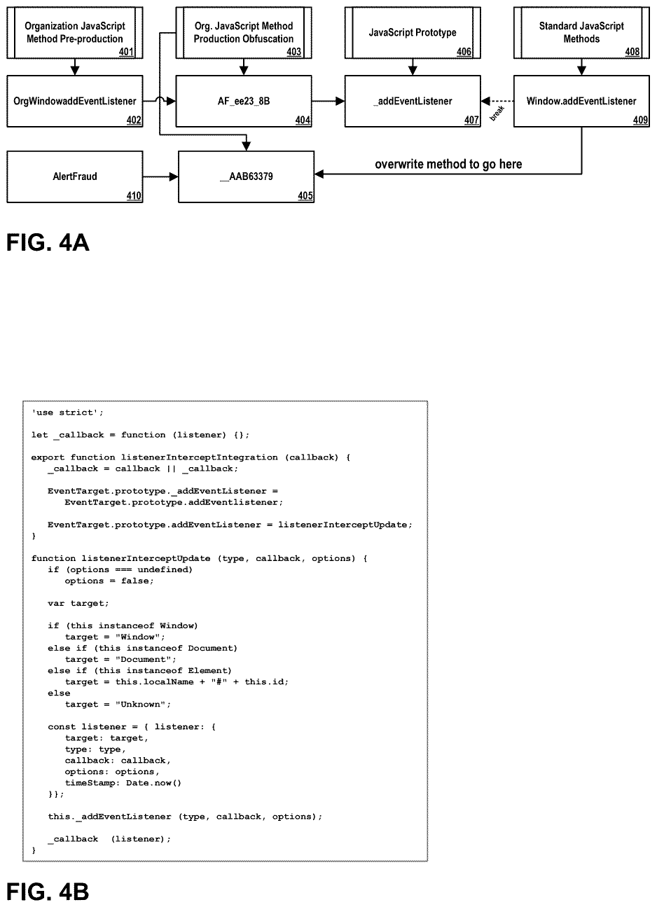

FIG. 4A is a flow diagram illustrating how method calls to various functions in an example JavaScript implementation may be processed, in accordance with one or more aspects of the present disclosure. FIG. 4A is similar to FIGS. 1B and 1C because FIG. 4A also illustrates how calls to various functions can be redirected or rerouted to other functions and renamed in order to complicate attempts to hack the web page. As illustrated in FIG. 4A, some methods 401 may be implemented as pre-production versions (OrgWindowaddEventListener(), block 402 or AlertFraud(), block 410), while other methods may be considered production versions 403, which are typically renamed/obfuscated versions of the pre-production versions (e.g., AF_ee23_8B, block 404, and __AAB63379, block 405).

In FIG. 4A, calls to a standard JavaScript method, such as “Window.addEventListener” (block 409) are redirected to __AAB63379 (block 405). Accordingly, “Window.addEventListener” (block 409) may generally correspond to StandardMethod() 153 of FIG. 1B, in the sense that calls to Window.addEventListener() are redirected to another function (“__AAB63379,” block 405), which causes unproductive work to be performed.

The JavaScript prototype method “_addEventListener()” (block 407) may correspond to AltStandardMethod() 152 because it calls the underlying, non-redirected version of another function (i.e., the JavaScript Window.addEventListener method, block 409). Also, “OrgWindowaddEventListener” (block 402) calls an obfuscated method, “AF_ee23_8B” (block 404), which calls “_addEventListener” (block 402). Accordingly, “OrgWindowaddEventListener” (block 402) generally corresponds to EnhancedMethod() 151 of FIG. 1B, and “AF_ee23_8B” (block 404) generally corresponds to obfuscated EnhancedMethod() 151′ of FIG. 1C.

FIG. 4B is a code listing illustrating an example of how JavaScript code implementing some of the techniques described herein may be implemented, in accordance with one or more aspects of the present disclosure. In FIG. 4B, the function “listenerInterceptUpdate()” is defined, and is the target of redirected calls to EventTarget.prototype.addEventListener.

FIG. 4B shows one specific implementation using JavaScript merely as an example. Techniques described herein may nevertheless take forms other than that illustrated in FIG. 4B, whether as JavaScript, another language, or within any applicable execution environment now known or hereafter developed.

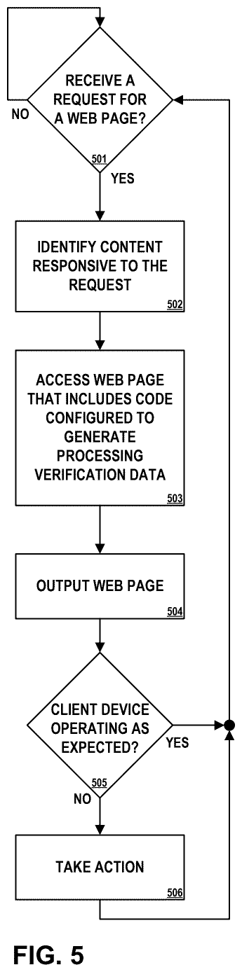

FIG. 5 is a flow diagram illustrating operations performed by an example computing system 220, in accordance with one or more aspects of the present disclosure. FIG. 5 is described below within the context of computing system 220 of FIG. 2. In other examples, operations described in FIG. 5 may be performed by one or more other components, modules, systems, or devices. Further, in other examples, operations described in connection with FIG. 5 may be merged, performed in a different sequence, omitted, or may encompass additional operations not specifically illustrated or described.

In the process illustrated in FIG. 5, and in accordance with one or more aspects of the present disclosure, computing system 220 may receive a request for a web page (501). For example, with reference to FIG. 2, communication unit 245 of computing system 220 detects a signal over network 105 and outputs information about the signal to web interaction module 251. Web interaction module 251 determines that the signal corresponds to request 101. Web interaction module 251 further determines that request 101 is a request for a web page from client device 110A.

Computing system 220 may identify content responsive to the request (502 and YES path from 501). For example, web interaction module 251 evaluates request 101 and identifies the requested content or the requested web page. In some examples, web interaction module 251 may access a library of information stored in data store 259 in order to identify content responsive to the request.

Computing system 220 may access a web page that includes the content responsive to the request and includes code configured to generate processing verification data (503). For example, web interaction module 251 accesses a responsive web page by generating a web page that includes the responsive content and that also includes JavaScript code. Typically, the JavaScript code is configured to execute at the client device 110A (e.g., in a browser instance) and perform various business logic operations (e.g., presenting banking account information, prompting a user for a username and password or for other information). Web interaction module 251 outputs information about the web page to verification module 252. Verification module 252 incorporates additional JavaScript code into the web page. This additional code is configured to generate, when the web page is loaded into a browser and is executing at client device 110A, a series of processing verifications 104 that may be communicated from client device 110A over network 105 back to computing system 220. In some examples, such processing verifications 104 may serve as “check-ins” that provide some assurance to computing system 220 that client device 110A is operating as expected. In some examples, verification module 252 may access the code capable of generating the processing verifications 104 from a library of functions (e.g., also stored in data store 259). Such library code may have been prepared in advance for the purpose of inclusion within web pages requested by client devices 110.

Computing system 220 may output the web page to the client device in response to the request (504). For example, web interaction module 251 packages the code from verification module 252 into a web page 102. Web interaction module 251 causes communication unit 245 to output web page 102 over network 105, destined for client device 110A. Client device 110A receives web page 102 and loads web page 102 into a browser at client device 110A. If client device 110A is a normal client device that is operated by a legitimate user, code within web page 102 will cause a stream of processing verifications 104 to be communicated over network 105 to computing system 220. If, however, client device 110A is a device that is seeking to hack computing system 220 by, for example, attempting to execute code other than that included within web page 102, some or all of the normal processing verifications 104 might not be communicated over network 105 to computing system 220.

Computing system 220 may determine, based on any processing verification data received from the client device over the network, whether the client device is operating as expected (505). For example, web interaction module 251 may receive a series of processing verifications 104 over network 105 from client device 110A. Web interaction module 251 may output information about the series of processing verifications 104 (if any) to threat assessment module 255. Threat assessment module 255 may determine whether some or all of the expected processing verifications 104 have been received as expected. If all of the processing verifications 104 have been received as expected, threat assessment module 255 may conclude that client device 110A is likely being operated by a legitimate user, and does not present a significant risk (YES path from 505). However, if some or all of the processing verifications 104 have not been received as expected, threat assessment module 255 may conclude that client device 110A is a risk, and may take action to address the risk (NO path from 505).

Computing system 220 may take action (506). For example, threat assessment module 255 may calculate a risk score that indicates that the client device represents a risk to assets maintained by an organization that owns, operates, and/or controls computing system 220. Threat assessment module 255 may cause communication unit 245 of computing system 220 to output one or more control signals 231 to one or more downstream system 230 based on determining that the client device represents a risk to the assets maintained by the organization. In some examples, threat assessment module 255 may send control signals 231 to a downstream system 230, instructing downstream system 230 to perform a specific operation, such as modifying or limiting network operations, requiring an additional authentication check, limiting funds transfers, or sending an alert. Downstream system 230 receives the one or more control signals 231 and performs the operations specified by control signals 231. Accordingly, computing system 220 controls the operation of downstream system 230 and/or connected infrastructure and systems through such control signals 231 and based on assessments made by threat assessment module 255.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

In the preceding description, references are sometimes made to “some examples.” In this disclosure, a reference to “some examples” is intended to mean a subset of all of the possible examples supported by the preceding description. Also, different references to “some examples” are not always a reference to the same subset of examples.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., web servers 120, client devices 110, computing systems 220, downstream systems 230, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be appropriate in other instances. Such implementations may include a subset of the devices and/or components included in the illustrations and/or may include additional devices and/or components not specifically illustrated.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, graphics processing units (GPUs), application specific integrated circuits (ASICs), field programmable logic arrays (FPGAs), quantum processors, or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
receiving, by a computing system and over a network from a client device, a request for a web page;
identifying, by the computing system, content responsive to the request;
accessing, by the computing system, a web page that includes the content responsive to the request and code referencing a first method and a second method, wherein the first method is configured to call the second method and is further configured to generate processing verification data;
outputting, by the computing system and responsive to the request, the web page to the client device; and
determining, by the computing system and based on processing verification data received from the client device over the network, whether the client device is operating as expected.

2. The method of claim 1, wherein accessing the web page includes:
generating the web page.

3. The method of claim 2, wherein generating the web page includes:
accessing a library of functions to implement the first method.

4. The method of claim 2, wherein generating the web page includes:
accessing a library of functions to implement code to cause the processing verification data to be output over the network by the client device.

5. The method of claim 2, wherein generating the web page includes:
configuring the code included in the web page to redirect calls to the second method to a third method, wherein the third method performs unproductive operations.

6. The method of claim 2, wherein generating the web page includes:
obfuscating the first method by renaming the first method.

7. The method of claim 6, wherein the request for the web page is a first request for a first web page, and wherein the method further comprises:
receiving, by the computing system and over the network from the client device, a second request for a second web page; and
generating, by the computing system, the second web page that includes code referencing the first method through an obfuscated name, wherein the obfuscated name is different than the renamed first method in the first web page.

8. The method of claim 1, wherein the computing system is controlled by an organization that maintains assets, and wherein determining whether the client device is operating as expected includes:
calculating a risk score that indicates that the client device represents a risk to the assets maintained by the organization.

9. The method of claim 8, further comprising:
performing, by the computing system, an action based on determining that the client device represents the risk to the assets maintained by the organization.

10. The method of claim 9, wherein performing the action includes:
sending, by the computing system, control signals to a downstream computing system, the control signals instructing the downstream computing system to modify its operation to mitigate the risk to the assets.

11. A computing system comprising processing circuitry and a storage device, wherein the processing circuitry has access to the storage device and is configured to:
receive, over a network from a client device, a request for a web page;
identify content responsive to the request;
access a web page that includes the content responsive to the request and code referencing a first method and a second method, wherein the first method is configured to call the second method and is further configured to generate processing verification data;
output, responsive to the request, the web page to the client device; and
determine, based on processing verification data received from the client device over the network, whether the client device is operating as expected.

12. The computing system of claim 11, wherein to access the web page, the processing circuitry is further configured to:
generate the web page.

13. The computing system of claim 12, wherein to generate the web page, the processing circuitry is further configured to:
access a library of functions to implement the first method.

14. The computing system of claim 12, wherein to generate the web page, the processing circuitry is further configured to:
access a library of functions to implement code to cause the processing verification data to be output over the network by the client device.

15. The computing system of claim 12, wherein to generate the web page, the processing circuitry is further configured to:
configure the code included in the web page to redirect calls to the second method to a third method, wherein the third method performs unproductive operations.

16. The computing system of claim 12, wherein to generate the web page, the processing circuitry is further configured to:
obfuscate the first method by renaming the first method.

17. The computing system of claim 16, wherein the request for a web page is a first request for a first web page and wherein the processing circuitry is further configured to:
receive, over the network from the client device, a second request for a second web page; and
generate the second web page that includes code referencing the first method through an obfuscated name, wherein the obfuscated name is different than the renamed first method in the first web page.

18. The computing system of claim 11, wherein the computing system is controlled by an organization that maintains assets, and wherein to determine whether the client device is operating as expected, the processing circuitry is further configured to:
calculate a risk score that indicates that the client device represents a risk to the assets maintained by the organization.

19. The computing system of claim 18, wherein the processing circuitry is further configured to
perform an action based on determining that the client device represents the risk to the assets maintained by the organization.

20. Non-transitory computer-readable media comprising instructions that, when executed, cause processing circuitry of a computing system to:
receive, over a network from a client device, a request for a web page;
identify content responsive to the request;
access a web page that includes the content responsive to the request and code referencing a first method and a second method, wherein the first method is configured to call the second method and is further configured to generate processing verification data;
output, responsive to the request, the web page to the client device; and
determine, based on processing verification data received from the client device over the network, whether the client device is operating as expected.
